(19) United States
(12) Patent Application Publication
(10) Pub. No.: US 2026/0102997 A1
(43) Pub. Date: Apr. 16, 2026

(54) VACUUM LAMINATION METHOD

(71) Applicant: GROUP UP INDUSTRIAL CO., LTD., Taoyuan City (TW)

(72) Inventor: An-Shun Chen, Taoyuan City (TW)

(73) Assignee: GROUP UP INDUSTRIAL CO., LTD., Taoyuan City (TW)

(21) Appl. No.: 19/049,111

(22) Filed: Feb. 10, 2025

(30) Foreign Application Priority Data
Oct. 14, 2024 (TW) 113139033

(51) Int. Cl. B32B 37/10; B32B 37/22; B32B 38/00

(52) U.S. Cl. CPC B32B 37/1018; B32B 37/223; B32B 38/0004

(57) ABSTRACT

A vacuum lamination method, comprising providing a vacuum lamination device, which comprises an upper lamination unit and a lower lamination unit; providing a sealing film and a substrate; moving at least one of the upper lamination unit and the lower lamination unit, the upper lamination unit and the lower lamination unit are brought close to and joined to each other, and the upper lamination unit and the lower lamination unit jointly surround and form a chamber, the sealing film and the substrate are accommodated in the chamber, and the sealing film and the substrate are not in contact with each other; evacuating the chamber; moving at least one of the sealing film and the substrate to bring the sealing film and the substrate close to each other, so that the sealing film is laminated onto the substrate.

### BACKGROUND OF THE INVENTION

### Technical Field

The present invention relates generally to substrate packaging, and more particularly to a lamination method using thin film packaging.

### Description of Related Art

It is known that a general lamination method is to cover a surface of a substrate with a sealing film and then use vacuum to extract a residual gas between the sealing film and the substrate so that the sealing film is attached to the substrate, and then heat and press the sealing film to make the sealing film bond to the substrate.

However, when the surface of the substrate has a highly undulating structure or the sealing film and the substrate surface are too closely attached, the residual gas between the sealing film and the substrate cannot be extracted by vacuuming. In this way, it is easy for air bubbles to exist between the sealing film and the substrate, resulting in poor packaging yield. Therefore, the conventional lamination method still needs to be improved.

### BRIEF SUMMARY OF THE INVENTION

In view of the above, the primary objective of the present invention is to provide a vacuum lamination method that could effectively reduce air bubbles between a sealing film and a substrate, which could achieve the purpose of improving the packaging yield.

The present invention provides a vacuum lamination method, which comprises: (a) providing a vacuum lamination device, which comprises an upper lamination unit and a lower lamination unit, wherein the upper lamination unit and the lower lamination unit are movable relative to each other; (b) providing a sealing film and a substrate, wherein the substrate and the sealing film are provided between the upper lamination unit and the lower lamination unit, a predetermined distance is provided between the sealing film and the substrate, and the sealing film and the substrate are not in contact with each other; (c) moving at least one of the upper lamination unit and the lower lamination unit to bring the upper lamination unit and the lower lamination unit close to each other and to join to each other, and the upper lamination unit and the lower lamination unit are surrounded to form a chamber, wherein the sealing film and the substrate are accommodated in the chamber; in step (c), the sealing film and the substrate are not in contact with each other; (d) evacuating the chamber; (e) moving at least one of the sealing film and the substrate to bring the sealing film and the substrate close to each other, so that the sealing film is laminated onto the substrate; (f) heating the sealing film and the substrate; (g) releasing the vacuum in the chamber; and (h) moving at least one of the upper lamination unit and the lower lamination unit to separate the upper lamination unit and the lower lamination unit from each other.

The effect of the present invention is that by executing the step of evacuating the chamber before the sealing film and the substrate are in contact with each other, the sealing film could be closely attached to each other when the sealing film is laminated on the substrate, and air bubbles between the sealing film and the substrate could be reduced, thereby achieving the purpose of improving packaging yield.

### BRIEF DESCRIPTION OF THE SEVERAL VIEWS OF THE DRAWINGS

The present invention will be best understood by referring to the following detailed description of some illustrative embodiments in conjunction with the accompanying drawings, in which

FIG. 1 is a flowchart of the vacuum lamination method according to an embodiment of the present invention;

FIG. 2 is a flowchart of the vacuum lamination method according to the embodiment of the present invention;

FIG. 3 is a schematic view of the vacuum lamination device according to the embodiment of the present invention showing the upper lamination unit comprises an upper heating plate, and a soft material pad and the lower lamination unit comprises a lower heating plate and a lifting rod;

FIG. 4 is another schematic view of the vacuum lamination device according to the embodiment of the present invention;

FIG. 5 is still another schematic view of the vacuum lamination device according to the embodiment of the present invention showing the substrate is provided on the lifting rod;

FIG. 6 is still another schematic view of the vacuum lamination device according to the embodiment of the present invention showing the lifting rod is moved downward;

FIG. 7 is still another schematic view of the vacuum lamination device according to the embodiment of the present invention showing the upper lamination unit is moved toward the lower lamination unit;

FIG. 8 is still another schematic view of the vacuum lamination device according to the embodiment of the present invention showing the sealing film and the substrate are clamped and pressed between the upper lamination unit and the lower lamination unit;

FIG. 9 is still another schematic view of the vacuum lamination device according to the embodiment of the present invention showing the upper lamination unit is moved in a direction away from the lower lamination unit;

FIG. 10 is still another schematic view of the vacuum lamination device according to the embodiment of the present invention showing the part of the carrier film rolled out of the carrier film roll is separated from the sealing film attached to the substrate;

FIG. 11 is still another schematic view of the vacuum lamination device according to the embodiment of the present invention showing the lifting rod is controlled to move upward;

FIG. 12 is still another schematic view of the vacuum lamination device according to the embodiment of the present invention;

FIG. 13 is still another schematic view of the vacuum lamination device according to the embodiment of the present invention showing the outer cover is controlled to return to a position where the upper opening of the outer cover is higher than the upper opening of the inner cover;

FIG. 14 is still another schematic view of the vacuum lamination device according to the embodiment of the present invention showing the carrier film roll outputs a carrier film through a carrier transport device;

FIG. 15 is still another schematic view of the vacuum lamination device according to the embodiment of the present invention showing the cutting device cuts the part of the sealing film rolled out of the sealing film roll to form the sealing film;

FIG. 16 is still another schematic view of the vacuum lamination device according to the embodiment of the present invention showing the carrier transport device is controlled to transport the sealing film.

### DETAILED DESCRIPTION OF THE INVENTION

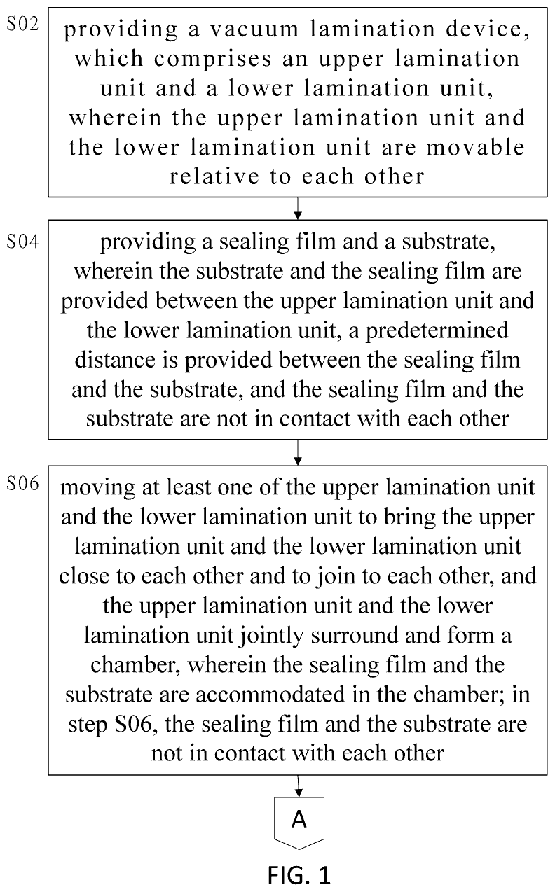

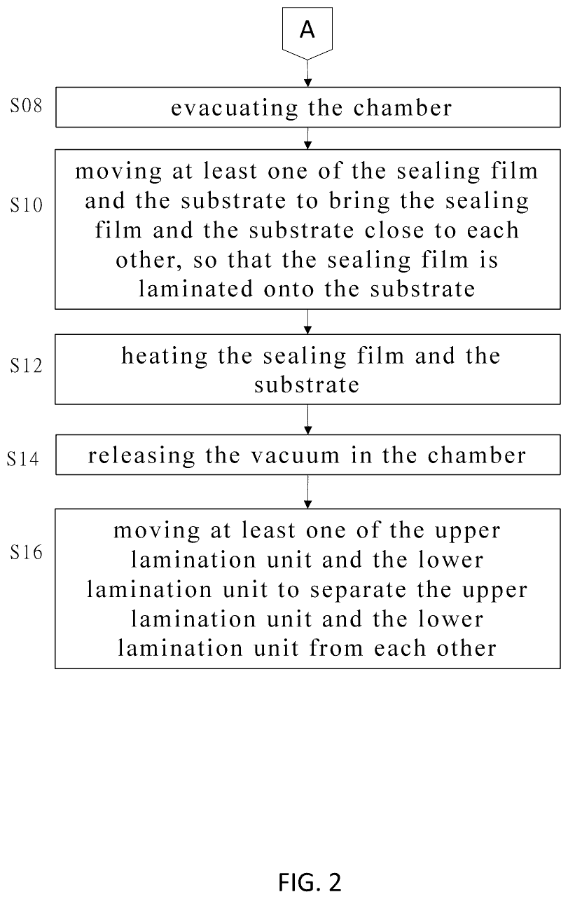

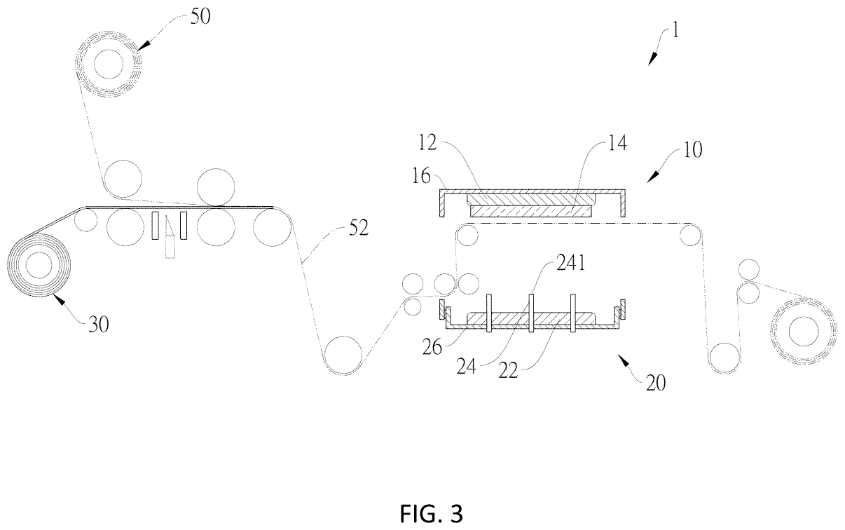

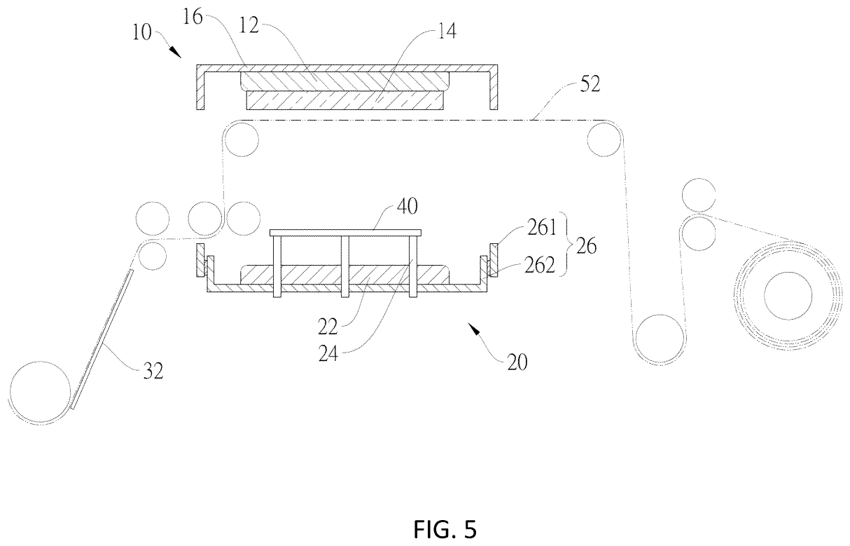

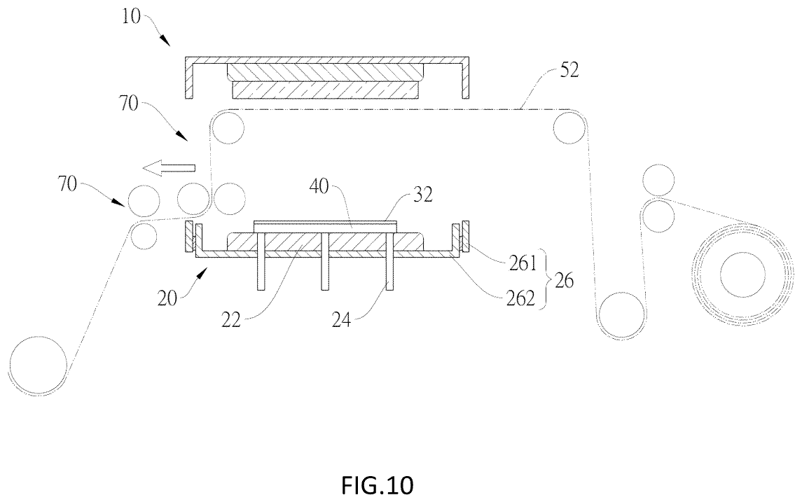

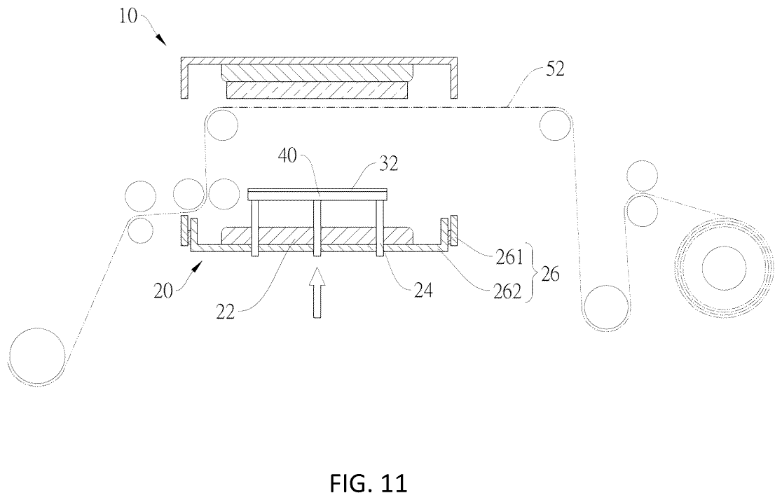

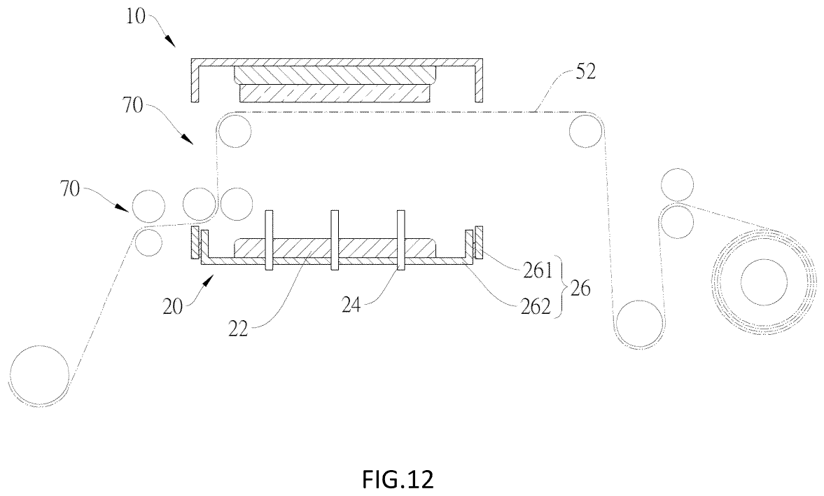

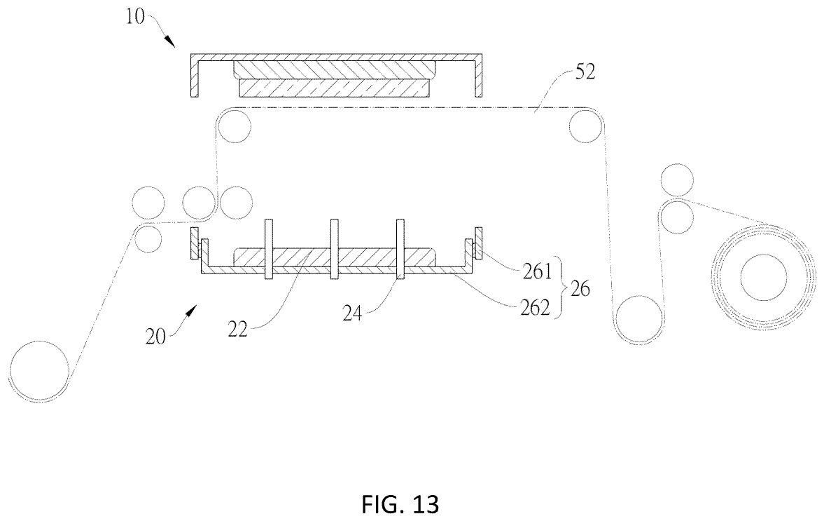

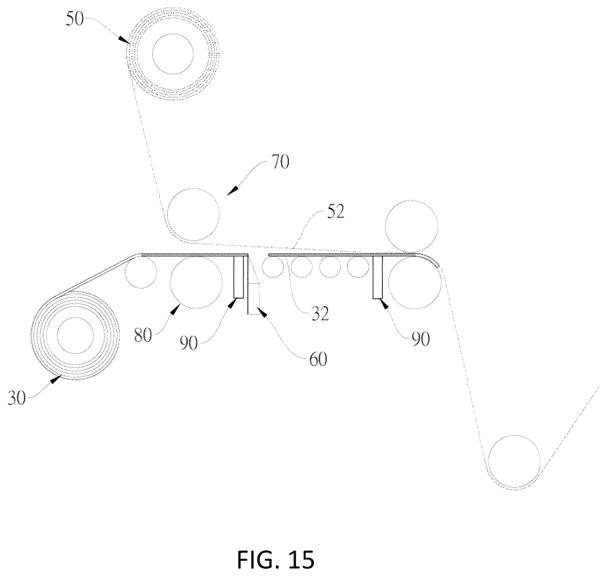

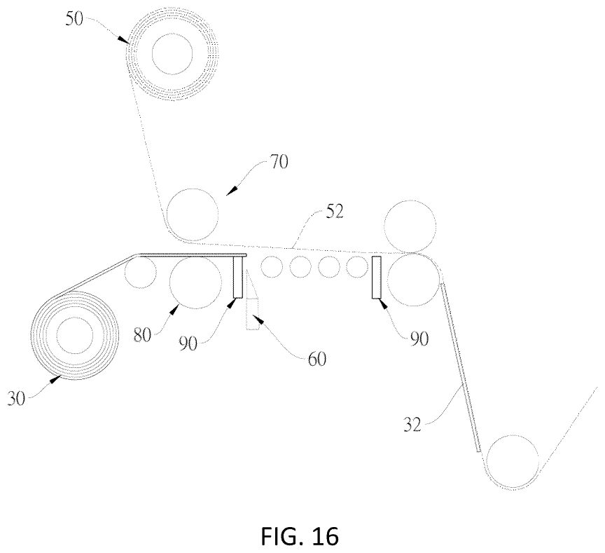

A flow charts of a vacuum lamination method according to an embodiment of the present invention is illustrated in FIG. 1 and FIG. 2. FIG. 3 to FIG. 16 are schematic operational flow diagrams of lamination. The vacuum lamination method includes the following steps.

Step S02: providing a vacuum lamination device 1. The vacuum lamination device 1 includes an upper lamination unit 10 and a lower lamination unit 20. The upper lamination unit 10 and the lower lamination unit 20 could move relative to each other. As shown in FIG. 3, the upper lamination unit 10 includes an upper heating plate 12, a soft material pad 14 and an upper cover 16 with a downward opening. The upper heating plate 12 and the soft material pad 14 are stacked and provided in the upper cover 16. The lower lamination unit 20 includes a lower heating plate 22, a lifting rod 24, and a lower cover 26 with an upward opening. The lower heating plate 22 and the lifting rod 24 are provided in the lower cover 26, the lifting rod 24 is embedded in the lower heating plate 22, the lifting rod 24 has a support portion 241, and the lifting rod 24 could be controlled to move up and down relative to the lower heating plate 22.

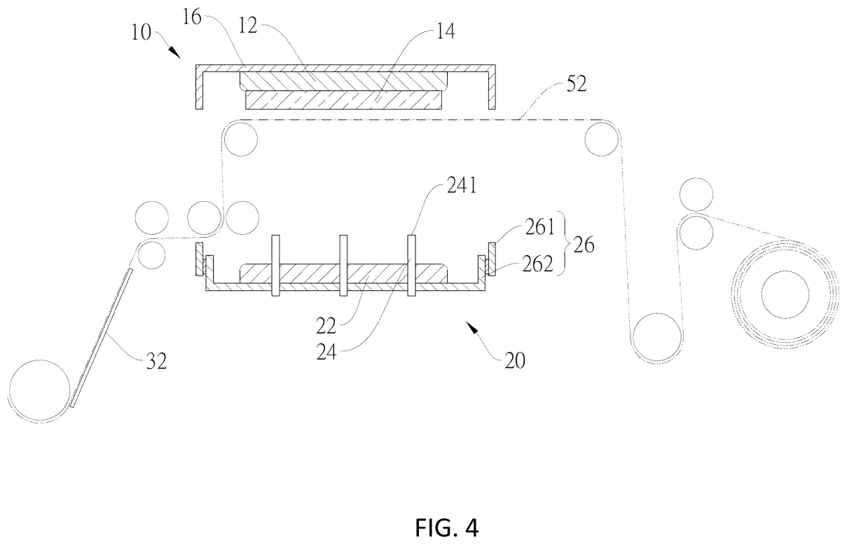

Step S04: providing a sealing film 32 and a substrate 40 as shown in FIG. 4 to FIG. 6. The substrate 40 and the sealing film 32 are provided between the upper lamination unit 10 and the lower lamination unit 20, the substrate 40 is provided on the lower lamination unit 20, the sealing film 32 is provided between the upper lamination unit 10 and the substrate 40, a predetermined distance is provided between the sealing film 32 and the substrate 40, and the sealing film 32 and the substrate 40 are not in contact with each other. Furthermore, the sealing film 32 could be a photosensitive sealing film or a dry film, but not limited thereto. The substrate 40 is provided on the support portion 241 of the lower lamination unit 20. Step S04 includes controlling the lifting rod 24 to grip the substrate 40 by vacuum and controlling the substrate 40 and the lifting rod 24 to move downward so that the substrate 40 could contact the lower heating plate 22, therefore the substrate 40 could be stably provided on the lifting rod 24, and the lower heating plate 22 could heat the substrate 40. In the embodiment, the substrate 40 is placed on the support portion 241 of the lower lamination unit 20 through a robot arm, but not limited thereto. In the embodiment, a suction hole is provided at a top end of the lifting rod 24 and air is extracted through an air extraction device to grip the substrate 40 by vacuum as an example for illustration. In practice, a plurality of suction holes could also be provided in the lower heating plate 22 and air is extracted through an air extraction device, which could also achieve the effect of gripping the substrate 40. The sealing film 32 refers to a film used in the IC substrate manufacturing or packaging process, including but not limited to build-up films, photoresist dry films, protective films, solder resist films, etc.

Furthermore, in the embodiment, the substrate 40 is provided on the lower lamination unit 20 and the sealing film 32 is provided between the upper lamination unit 10 and the substrate 40 as an example. In other embodiments, the substrate 40 could be provided on the upper lamination unit 10, and the sealing film 32 may be provided between the lower lamination unit 20 and the substrate 40.

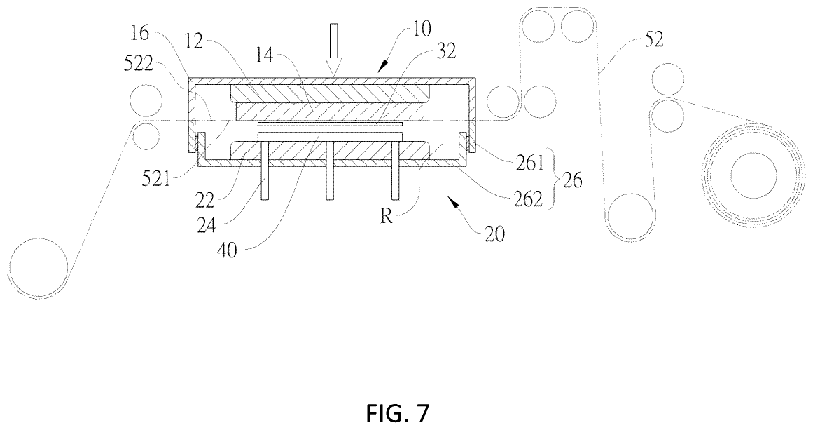

Step S06: moving at least one of the upper lamination unit 10 and the lower lamination unit 20, so that the upper lamination unit 10 and the lower lamination unit 20 are moved toward each other and are joined to each other, the upper lamination unit 10 and the lower lamination unit 20 jointly surround and form a chamber R, and the sealing film 32 and the substrate 40 are accommodated in the chamber. At this time, the sealing film 32 and the substrate 40 are not in contact with each other. As shown in FIG. 7, in the embodiment, moving the upper lamination unit 10 toward the lower lamination unit 20 is used as an example for illustration. In other embodiments, the upper lamination unit 10 and the lower lamination unit 20 could be moved to approach and join each other, or the lower lamination unit 20 could be moved toward the upper lamination unit 10 to approach the upper lamination unit 10 and join to the upper lamination unit 10, which could also achieve the effect that the upper lamination unit 10 and the lower lamination unit 20 jointly surround and form the chamber R.

Furthermore, the lower cover 26 includes an outer cover 261 and an inner cover 262. The outer cover 261 is arranged around an outer periphery of the inner cover 262 and could be controlled to move up and down relative to the inner cover 262. As shown in FIG. 7, in an initial state, an upper opening of the outer cover 261 is disposed at a position higher than an upper opening of the inner cover 262. Step S06 includes moving the upper cover 16 toward the lower cover 26 so that the upper cover 16 and the outer cover 261 could be joined to each other to form the chamber R.

Step S08: evacuating the chamber R; during an evacuation period, the predetermined distance is maintained between the sealing film 32 and the substrate 40. In other words, during the evacuation period, the sealing film 32 and the substrates 40 are not in contact with each other, so that a gas between the sealing film 32 and the substrate 40 could be removed. In this way, when the sealing film 32 is laminated on the substrate 40, the sealing film 32 and the substrate 40 could be closely attached to each other and air bubbles between the sealing film 32 and the substrate 40 could be reduced, thereby achieving the purpose of improving the packaging yield.

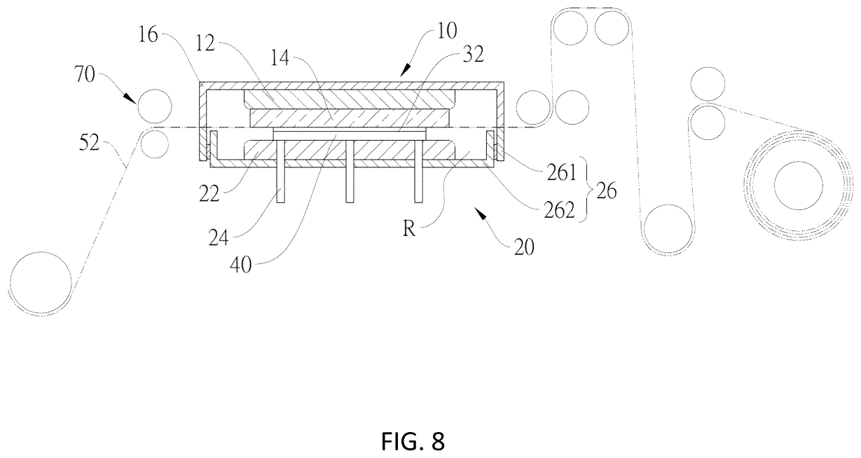

Step S10: moving at least one of the sealing film 32 and the substrate 40 to bring the sealing film 32 and the substrate 40 close to each other, so that the sealing film 32 is laminated onto the substrate 40. In the embodiment, as shown in FIG. 8, the upper lamination unit 10 is moved toward the lower lamination unit 20, so that the sealing film 32 and the substrate 40 are clamped and pressed between the upper lamination unit 10 and the lower lamination unit 20, and the sealing film 32 is attached to the substrate 40. In other embodiments, the upper lamination unit 10 and the lower lamination unit 20 could be moved closer to each other, or the lower lamination unit 20 could be moved toward to the upper lamination unit 10, which could also achieve the effect of clamping and pressing the sealing film 32 and the substrate 40 between the upper lamination unit 10 and the lower lamination unit. In addition, in the embodiment, a pressure is applied to the sealing film 32 and the substrate 40 through the soft material pad 14 of the upper lamination unit 10 and the lower lamination unit 20. In practice, the pressure could also be applied to the sealing film 32 and the substrate 40 in other ways. For example, the soft material pad 14 of the upper lamination unit 10 could be replaced by a pressure roller, and the pressure roller applies the pressure on sealing film 32 and the substrate 40 by rolling on the sealing film 32, so that the sealing film 32 and the substrate 40 are closely attached to each other.

In addition, in the embodiment, the soft material pad 14 of the upper lamination unit 10 is provided, so that when the upper lamination unit 10 and the lower lamination unit 20 press the sealing film 32 and the substrate 40, the sealing film 32 could more conform to an uneven surface of the substrate 40 and fit tightly and evenly to the substrate 40. The soft material pad 14 could be, for example, a soft material pad made of silicone or rubber. In other embodiments, a user may not provide the soft material pad 14 depending on the usage conditions.

Step S12: heating the sealing film 32 and the substrate 40. In the embodiment, the sealing film 32 and the substrate 40 are heated by the upper heating plate 12 of the upper pressing unit 10 and the lower heating plate 22 of the lower pressing unit 20. In other embodiments, the sealing film 32 and the substrate 40 could also be heated through at least one of the upper heating plate 12 and the lower heating plate 22.

Step S14: releasing the vacuum in the chamber.

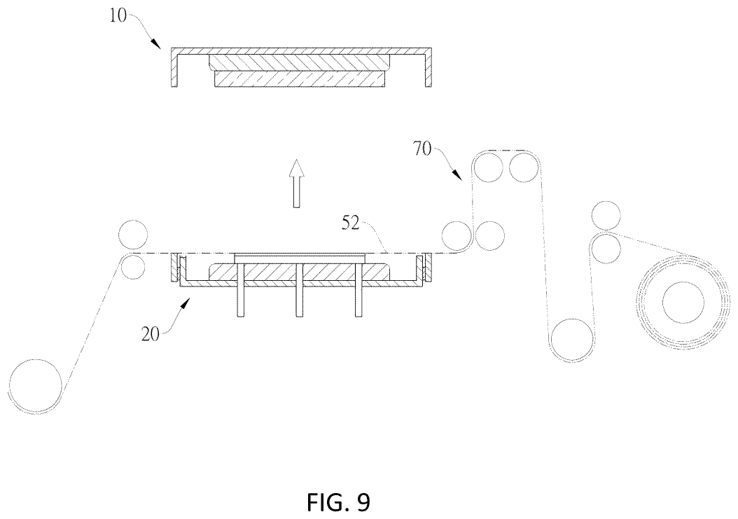

Step S16: moving at least one of the upper lamination unit 10 and the lower lamination unit 20 to separate the upper lamination unit 10 and the lower lamination unit 20 from each other. As shown in FIG. 9, in the embodiment, the upper lamination unit 10 is moved in a direction away from the lower lamination unit 20 to disengage the upper lamination unit 10 from a position where the upper lamination unit 10 is joined to the lower lamination unit 20. In other embodiments, both the upper lamination unit 10 and the lower lamination unit 20 could be moved away from each other, or the lower lamination unit 20 could be moved in a direction away from the upper lamination unit 10, which could also achieve the effect of disengaging the upper lamination unit 10 from the position where the upper lamination unit 10 is joined to the lower lamination unit 20.

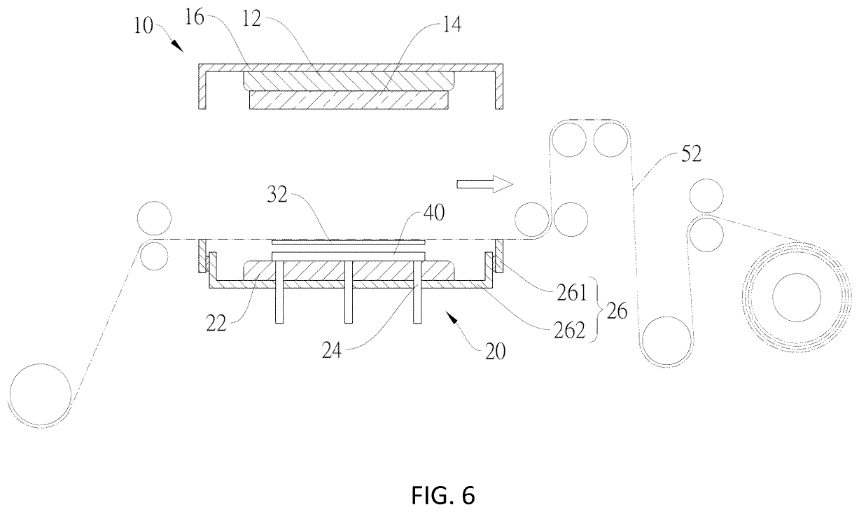

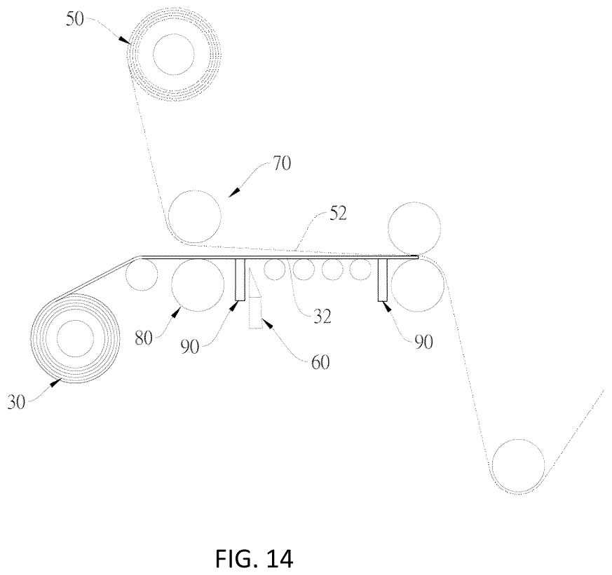

Furthermore, in the embodiment, the vacuum lamination method further includes a step of providing a carrier film roll 50, a sealing film roll 30, and a cutting device 60. As shown in FIG. 14 to FIG. 16, the carrier film roll 50 outputs a carrier film 52 through a carrier transport device 70. The carrier transport device 70 includes a plurality of rollers. The sealing film roll 30 outputs the sealing film 32 through a sealing film transport device 80. Through the transportation of the carrier transport device 70 and the sealing film transport device 80, a part of the sealing film rolled out of the sealing film roll 30 and a part of the carrier film 52 rolled out of the carrier film roll 50 face each other and are close to each other. The part of the sealing film rolled out of the sealing film roll 30 is gripped and fixed by a vacuum device 90, and then the cutting device 60 cuts the part of the sealing film rolled out of the sealing film roll 30 to form the sealing film 32. And because the part of the sealing film rolled out of the sealing film roll 30 and the part of the carrier film 52 rolled out of the carrier film roll 50 are arranged facing and adjacent to each other, the sealing film 32 formed through cutting could be attached to the part of the carrier film 52 rolled out of the carrier film roll 50. Then, the carrier transport device 70 is controlled to transport the sealing film 32 attached to the part of the carrier film 52 rolled out of the carrier film roll 50 to a position between the upper lamination unit 10 and the substrate 40 as shown in FIG. 6, and through a forward rotation and a reverse rotation of the plurality of rollers of the carrier transport device 70, a position of the sealing film 32 where the sealing film 32 is moved and located above the substrate 40 is adjusted, and the carrier film roll 50 is in contact with a top edge of the outer cover 261. In addition, during performing the step of evacuating the chamber R, since the sealing film 32 is attached to the carrier film 52 and the carrier film 52 is tightened through the rollers of the carrier transport device 70, the sealing film 32 could be restricted by the carrier film 52 to keep the predetermined distance from the substrate 40 without contacting each other.

Furthermore, step S04 includes transporting, by the plurality of rollers of the carrier transport device 70, the sealing film 32 attached to the carrier film roll 50 to the position between the upper lamination unit 10 and the substrates 40 as shown in FIG. 6, and controlling the lifting rod 24 to move downward. An execution order of the above two steps could be reversed depending on the user's usage status.

As shown in FIG. 7, the sealing film 32 is attached to a first surface 521 of the carrier film 52 output from the carrier film roll 50, and one side of the soft material pad 14 is in contact with the upper heating plate 12. Step S06 further includes moving the upper lamination unit 10 to a position where the other side of the soft material pad 14 opposite to the upper heating plate 12 abuts against a second surface 522 of the carrier film 52 output by the carrier film roll 50, wherein the first surface 521 is opposite to the second surface 522.

As shown in FIG. 8, step S10 further includes controlling the upper lamination unit 10 and the outer cover 261 to move downward, and controlling the carrier transport device 70 to drive the part of the carrier film 52 rolled out of the carrier film roll 50 to follow the upper lamination unit 10 and the outer cover 261 to move downward simultaneously, so that the sealing film 32 and the substrate 40 are attached to each other and are clamped between the upper lamination unit 10 and the lower lamination unit 20.

As shown in FIG. 9 to FIG. 13, when the upper lamination unit 10 is disengaged from the position of joining the lower lamination unit 20, step S16 further includes controlling the carrier transport device 70 to drive the part of the carrier film 52 rolled of the carrier film roll 50 to move upward, so that the part of the carrier film 52 rolled out of the carrier film roll 50 is separated from the sealing film 32 attached to the substrate 40. After the sealing of the substrate 40 is completed, the lifting rod 24 is controlled to move upward and stop gripping the substrate 40 to facilitate taking out the sealed substrate 40. Then, the outer cover 261 is controlled to return to a position where the upper opening of the outer cover 261 is higher than the upper opening of the inner cover 262 to facilitate the next laminating.

In summary, the effect of the present invention is that by performing an evacuating step before the sealing film 32 and the substrate 40 are in contact with each other, both the sealing film 32 and the substrate 40 could be closely attached to each other and air bubbles between the sealing film 32 and the substrate 40 could be effectively reduced when the sealing film 32 is laminated on the substrate 40, thereby achieving the purpose of improving the yield rate.

It must be pointed out that the embodiments described above are only some preferred embodiments of the present invention. All equivalent structures and methods which employ the concepts disclosed in this specification and the appended claims should fall within the scope of the present invention.

What is claimed is:

1. A vacuum lamination method, comprising:
step (a) providing a vacuum lamination device, which comprises an upper lamination unit and a lower lamination unit, wherein the upper lamination unit and the lower lamination unit are movable relative to each other;
step (b) providing a sealing film and a substrate, wherein the substrate and the sealing film are provided between the upper lamination unit and the lower lamination unit, a predetermined distance is provided between the sealing film and the substrate, and the sealing film and the substrate are not in contact with each other;
step (c) moving at least one of the upper lamination unit and the lower lamination unit to bring the upper lamination unit and the lower lamination unit close to each other and to join to each other, and the upper lamination unit and the lower lamination unit jointly surround and form a chamber, wherein the sealing film and the substrate are accommodated in the chamber; in step (c), the sealing film and the substrate are not in contact with each other;
step (d) evacuating the chamber;
step (e) moving at least one of the sealing film and the substrate to bring the sealing film and the substrate close to each other, so that the sealing film is laminated onto the substrate;
step (f) heating the sealing film and the substrate;
step (g) releasing the vacuum in the chamber; and
step (h) moving at least one of the upper lamination unit and the lower lamination unit to separate the upper lamination unit and the lower lamination unit from each other.

2. The vacuum lamination method as claimed in claim 1, further comprising providing a carrier film roll, wherein the substrate is provided on the lower lamination unit, the sealing film is provided between the upper lamination unit and the substrate, the carrier film roll outputs a carrier film through a carrier transport device, the sealing film is attached to the carrier film output from the carrier film roll, and the carrier transport device transports the sealing film attached to the carrier film roll to a position between the upper lamination unit and the substrate, and positioning the sealing film above the substrate.

3. The vacuum lamination method as claimed in claim 2, wherein step (e) further comprises moving at least one of the upper lamination unit and the lower lamination unit, so that the upper lamination unit and the lower lamination unit are closer to each other, and the sealing film and the substrate are clamped between the upper lamination unit and the lower lamination unit.

4. The vacuum lamination method as claimed in claim 3, wherein the sealing film is attached to a first surface of the carrier film output from the carrier film roll, and the upper lamination unit abuts against a second surface of the carrier film output from the carrier film roll; the first surface is opposite to the second surface.

5. The vacuum lamination method as claimed in claim 4, wherein the upper lamination unit comprises a upper heating plate and a soft material pad stacked on each other, and a side of the soft material pad is in contact with the upper heating plate; wherein step (c) comprises moving the upper lamination unit so that the other side of the soft material pad opposites to the upper heating plate abuts against the second surface of the carrier film output from the carrier film roll.

6. The vacuum lamination method as claimed in claim 5, wherein the upper lamination unit comprises an upper cover with a downward opening, and the lower lamination unit comprises a lower cover with an upward opening; wherein step (c) comprises moving the upper cover closer to the lower cover and joining the upper cover and the lower cover to form the chamber; wherein the upper heating plate and the soft material pad are provided in the upper cover.

7. The vacuum lamination method as claimed in claim 6, wherein the lower cover comprises an outer cover and an inner cover, and the outer cover is positioned around an outer periphery of the inner cover and capable of being controlled to move up and down relative to the inner cover; wherein step (c) comprises moving the upper cover toward the outer cover to bring the upper cover to join to the outer cover, thereby the upper cover and the outer cover jointly surround and form the chamber; wherein step (e) comprises moving the upper lamination unit and the outer cover downward so that the sealing film and the substrate are clamped between the upper lamination unit and the lower lamination unit.

8. The vacuum lamination method as claimed in claim 6, wherein the lower lamination unit comprises a lower heating plate and a suction device provided in the lower cover, the suction device is embedded in the lower heating plate, the suction device has a support portion for supporting the substrate, and the suction device is capable of being controlled to move up and down relative to the lower heating plate; wherein step (b) comprises placing the substrate on the support portion, controlling the suction device to grip the substrate, and controlling the suction device to move downward so that the substrate contacts the lower heating plate.

9. The vacuum lamination method as claimed in claim 7, wherein when the carrier transport device transports the sealing film attached to the carrier film roll to the position between the upper lamination unit and the substrate and the sealing film is positioned above the substrate, the carrier film roll is in contact with a top edge of the outer cover; wherein step (e) comprises controlling the carrier transport device to drive the carrier film roll to move downward synchronously with the upper lamination unit and the outer cover.

10. The vacuum lamination method as claimed in claim 2, further comprising providing a sealing film roll and a cutting device, wherein the sealing film roll outputs the sealing film through a sealing film transport device, and the cutting device cuts the sealing film output from the sealing film roll to form the sealing film.
